(19) United States
(12) Patent Application Publication
(10) Pub. No.: US 2012/0056017 A1
(43) Pub. Date: Mar. 8, 2012

(54) Spray Gun Tank Configurations

(76) Inventors: Scott Thomason, Macedonia, OH (US); Steven C. Cooper, Athens, GA (US)

(21) Appl. No.: 13/280,317

(22) Filed: Oct. 24, 2011

Related U.S. Application Data
(63) Continuation-in-part of application No. 12/910,754, filed on Oct. 22, 2010.
(60) Provisional application No. 61/266,810, filed on Dec. 4, 2009.
(60) Provisional application No. 61/405,828, filed on Oct. 22, 2010.

(51) Int. Cl. B05B 9/04; B05B 15/00

(52) U.S. Cl. 239/373

(57) ABSTRACT

A container for holding a spray or coating material that is adapted to and operates with a spray system for spraying or coating operations. The container may include an auxiliary port capable of maintaining pressure in the system and does not need to be removed from the system to be filled or refilled with the spray or coating material. The container may be filled or refilled during operation. The auxiliary port is continuous with the container. The container does not require a separable layer or liner. The container may be non-collapsible. The container is adapted to the spray system through a separate aperture that does not require a valve for closing the separate aperture. The spray system may further comprise a mechanism for heating the material in the container and/or before exiting the spray system.

### CROSS-REFERENCE TO RELATED APPLICATIONS

This application claims priority from U.S. Provisional Application No. 61/405,828, filed Oct. 22, 2010, the disclosure of which is hereby incorporated by reference in its entirety. The application also claims priority from U.S. patent application Ser. No. 12/910,754, filed Oct. 22, 2010, which claims the benefit of U.S. Provisional Application No. 61/266,810, filed Dec. 4, 2009; the disclosure of each are hereby incorporated by reference in their entirety.

### BACKGROUND

The invention pertains generally to a system for spraying or coating operations. In one or more embodiments, said system includes a device for spraying or coating and a feed container with an auxiliary aperture.

Typical devices for spraying or coating require removal and cleaning of a feed container for refilling or changing the fluid (gas or liquid) or other materials (solid, semi-solid or gelatenous) to be sprayed or coated. Removal and refilling or cleaning can be time consuming and may affect the quality and contamination of the coating being applied. To avoid these issues, many feed containers have been developed that are either disposable and/or collapsible or have an inner layer that is separate from the container (often disposable and/or collapsible). Said feed containers still require removal of the container from the device or require a complicated feed to the device that can be both opened and closed.

### SUMMARY

Described herein are one or more spray systems and devices that overcome one or more of the current issues, such as those described above.

In one or more embodiments is a spray system comprising a means for spraying a spray or coating material and a means for holding the coating material. The means for spraying includes a body with an air inlet, an outlet, and a trigger. The means for holding includes a container or tank with a primary opening and an auxiliary port. The primary opening is in operable communication with the means for spraying. The primary opening will engage with the means for spraying. The primary opening does not require a valve or other operational device for opening and closing. The primary opening when configured with the device will allow flow of the coating material to the outlet. The system may further comprise a means for introducing pressure or suction to the system. The means for introducing pressure or suction when included is in operable communication with the means for spraying, typically via the air inlet and/or the trigger. The trigger operates to adjust air in order to expel the spray or coating material out of the outlet. The means for holding is configured as further described herein to maintain suitable spray conditions in the system. With or without pressure or suction in the system, the means for holding does not require removal to be filled or refilled with the spray or coating material. In some embodiments, the holding container may operate with a spray system that does not require a pressurized system or suction or venturi system. With such a system, the holding container or the auxiliary port is typically adapted with a one-way vent to allow continuous flow (e.g., allow pressure to equalize when there is a pressure differential in the system). With or without pressure or suction in the system, the holding container may fit wholly or partially above the body or on a top surface of the body (e.g., as a gravity feed container or as a rear-fill container) or as a bottom fill container. The means for holding does not require an inner liner or layer for operation. The means for holding may be non-collapsible. In addition, the means for holding does not require the device itself to be inverted when filling or refilling with the material. In some embodiments and when operating as a closed system, the means for holding does not require a separate vent or air hole for operation. When a valve or one-way vent is operable with the auxiliary port (e.g., check valve), it is not integral with the primary opening. The auxiliary port provides direct access into the container and not to a reservoir or liner or layer separable from the container.

Further described herein is a a spray system comprising a means for accepting a spray or coating material, a means for exiting the spray material, a means for holding the spray material and a means for filling the means for holding with the spray or coating material. The means for filling is separate from the means for holding and allows the system during operation to be filled or refilled with spray material without removal of the means for holding the spray material from the system or inversion of the spray system. When the system operates as a closed system, filling or refilling may still occur during operation. In one or more embodiments, the system as described is a closed system and maintains some pressure when in operation. In one form, the means for holding will include a primary opening that does not require a valve that transitions from an open to closed position and also includes the means for filling the means for holding. The means for filling is an auxiliary port that is closed when the system is in use. The auxiliary port may include a one-way vent or system that transitions from an open to a closed position. In another form, the means for filling is an auxiliary port located elsewhere on the system, such as on the means for accepting the spray material. The means for holding may comprise a container for gravity feed, suction feed, pressure feed, bottom feed or rear feed (e.g., back fill). As described, the system may operate with a one-way valve for maintaining flow or material when there is a pressure differential (e.g., using an passive or mechanically actuated mechanism). The one way valve may be associated with the auxiliary port or elsewhere in the system, such as with the means for accepting the spray or coating material. The system may also operate as a closed system replacing air with a non-collapsible means for holding the spray material.

Also described herein is a container for holding a spray or coating material that operates with a spray system for spraying or coating operations. The container includes a primary opening and an auxiliary port. The primary opening does not require a valve or member that transitions from an open to a closed position. The primary opening is generally configured to operably fit with the spray system. The configuration may be a press-fit, threaded fit or other suitable mechanical fit. The auxiliary port is capable of maintaining pressure in the system. The auxiliary port may include a one-way vent for maintaining pressure in the system. The container as described does not need to be removed from the system to be filled or refilled with the spray or coating material. In some embodiment, the container is only open when filling or refilling. The container does not require a reservoir or liner or separable layer. The container may or may not be collapsible. In some embodiments, the container is not collapsible or disposable. Generally the container is reusable, durable and rigid. The auxiliary port may be operable with a check (e.g., check valve) or opening device, said check or opening device is not integral with the primary opening. The auxiliary port provides direct access into the container and not to a reservoir or liner or a layer separable and from the container. When the auxiliary port includes a one-way valve, the container may be used without requiring a separate (independent) vent or air hole for operation. The container may be adapted for use as a gravity feed container or a bottom feed container or as a rear feed container. When filling or refilling the container through the auxiliary port, the device is not inverted from its normal operational position. In addition, the device may be filled or refilled with the same or with additional materials through the auxiliary port while in operation.

Those skilled in the art will further appreciate the above-noted features and advantages of the invention together with other important aspects thereof upon reading the detailed description that follows and in conjunction with the drawings.

### BRIEF DESCRIPTION OF THE DRAWINGS

For more complete understanding of the features and advantages of the inventions described herein, reference is now made to a description of the invention along with accompanying figures, wherein:

FIG. 1 illustrates in side view a representative spray system as described herein;

FIG. 2 is a representative holding container operable with a spray system, such as shown in FIG. 1;

FIG. 3 is another representative holding container;

FIG. 4 is a still further representative holding container for a top fed system described;

FIGS. 5 to 8 illustrate additional representative spray systems and containers as described herein;

FIGS. 9A and 9B illustrate cross sectional views of the spray system shown in FIG. 10 focusing on a representative operation of air and spray material control;

FIG. 10 illustrates a further cross sectional view of the sprayer system shown in FIGS. 7 and 8.

FIGS. 11A to 11C show a representative mechanical control system for controlling operation of the air and material control valves corresponding with FIGS. 9A and 9B; and

FIG. 12 shows an alternative mechanical control system controlling operation of the air and material control valves corresponding with FIGS. 9A and 9B.

### DESCRIPTION

Although making and using various embodiments are discussed in detail below, it should be appreciated that as described herein are provided many inventive concepts that may be embodied in a wide variety of contexts. Embodiments discussed herein are merely representative and do not limit the scope of the invention.

References will now be made to the drawings wherein like numerals refer to like or similar parts throughout. The drawing figures are not necessarily to scale and certain features may be shown exaggerated in scale or in somewhat generalized or schematic form in the interest of clarity and conciseness. In the following description, like numbers refer to like elements.

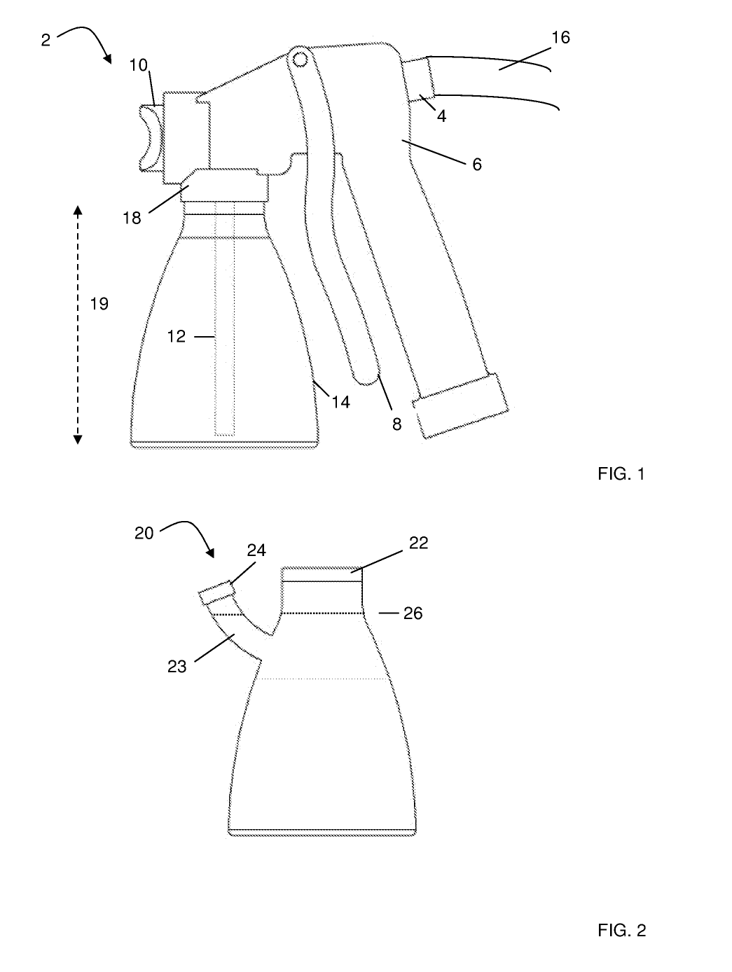

Referring to FIG. 1 is a spray system 2 comprising a body 6 generally operable with an air inlet 4 on one end and an outlet 10 on another end, which may be an end opposing the air inlet. The ends described do not have to directly oppose each other, although such a configuration is depicted in FIG. 1. The air inlet is in communication with a flow line, such as hose or piping or tubing 16, that, in one form is in direct communication with a pressurized system for introducing compressed air into the inlet. In such a configuration, compressed air enters via the inlet and flow of material exiting the outlet is adjusted by way of trigger 8. The compressed air may be heated before entry or heated by way of the body and components therein. The body is further operable with and in communication with a holding container 14. The holding container houses the material to be sprayed or coated. The material to be sprayed or coated may be any material suitable for spraying or coating. In some forms the material is a fluid (gas or liquid). In additional forms the material may be particulated with or without a solution or solvent. The material may be an emulsion or in a more gelatinous form. Still further, the material may be a material for spraying on skin and may, in some embodiments, include active tanning ingredients, such as erythrulose or dihydroxyacetone. The spray or coating material exits the system through outlet 10. The outlet may further comprise a shaped or configured spout or nozzle that changes the flow pattern or shape as the spray or coating material exits the outlet. The body with inlet, outlet and trigger may be represented by a suitable spray gun known for spraying and coating applications.

As shown in FIG. 1, the spray or coating material is bottom fed such that the holding container connects and communicates with the body on its lower surface, such as via connection 18. With such a configuration, the body will further comprise an elongated member 12. The elongated member will generally have a length that is equal to, a bit less than or a bit greater than the height of the holding container. The height is depicted as arrow 19 of FIG. 1. Connection 18 may be in the form of a flange, bore or suitable alternative that includes on its interior surface a configuration for allowing the holding container to securely fit with connection 18 in its interior surface. Such fitting may include a turn lock, screw fit or force fit. The fitting may include threading. The fitting may also include actuation of a mechanical release that is located on the body. In such embodiments, a container such as shown in FIG. 1 will require an additional vent or a collapsible liner or container for continuous flow of the material. As described herein, a container, such as depicted in FIG. 2 removes the necessity for an additional vent or a collapsible layer or collapsible container while allowing continuous flow of the material.

The holding container described herein is generally durable and made of a material resistant to chemical erosion. Suitable examples include but are not limited to a chemically resistant polymer or plastic (e.g., polycarbonate, polyethylene and polypropylene), aluminum alloy, metal alloy, and cast iron. The holding container may be opaque or may allow an operator to see to some extent contents within the container. The holding container does not require a liner or reservoir or separable layer. In several embodiments, the holding container is not collapsible. In said embodiments, the holding container is not considered to be disposable or of a disposable material suitable for only a single use. The holding container described herein also does not require a lid arrangement with separable parts in order to secure to the body of the spray system. The container has, instead, a primary opening configured to receive and be operable with the body, the configuration is continuous with and not separable from the container and does not require any additional element for fitting with the body or for opening and closing the primary opening. Thus, the primary opening does not require a valve device that transitions from an open to a closed position for connecting with the body of the spray system. Certain containers may be detachable through actuation of a release not located on the container but located on the body, as described further in FIG. 8.

Conventionally, bottom fed spray systems require the holding container to be removed from the body in order to refill with the same or new material. Removal results in complications, such as spilling of the material, is messy and inefficient. Conventionally, many top or gravity fed spray systems require the spray device to be removed or to be inverted from the body in order to refill with the same or new material. Inversion, like removal, results in additional complications as well as spilling of the material, is messy and inefficient. Many conventional containers also require a hole or opening in the container that remains open in order for proper operation. Instead, as described herein is a holding container that includes an auxiliary fill port. The auxiliary port overcomes a need to remove the holding container when filling or refilling. A container described herein with an auxiliary port does not require a hole or opening in the gravity fed container to remain open during operation. FIGS. 2-4 provide exemplary embodiments of holding containers described herein.

FIG. 2 illustrates a representative container 20 with auxiliary port 23. The auxiliary port is spaced apart from connection 22, which is where container 20 will generally fit with the body of a spray system, such as body 6 of FIG. 1. With such a container, a spray or coating material may, thus, be filled into container 20 via auxiliary port 24 without removing container 20 from the body. The fit between the body and container 20 is shown by way of 22, a primary opening, which may include a means for securing such as a force fit or screw fit or a turn lock, as suitable examples, as well as a mechanical release located on the body of the spray system. The auxiliary port will include at its end a check, such as a cap or seal or valve 24. Seal 24 may force fit or screw fit or turn lock or transition between an open and closed position with respect to the end of port 23. The fit should be suitable to retain pressure in the holding container when secured or closed. Cap 24 may also be in the form of a flip cap with sufficient fit to retain pressure in the holding container when closed and/or secured. In addition, the check may include a one-way valve for maintaining pressure in the system; the valve may be passive, the valve may be pressure actuated.

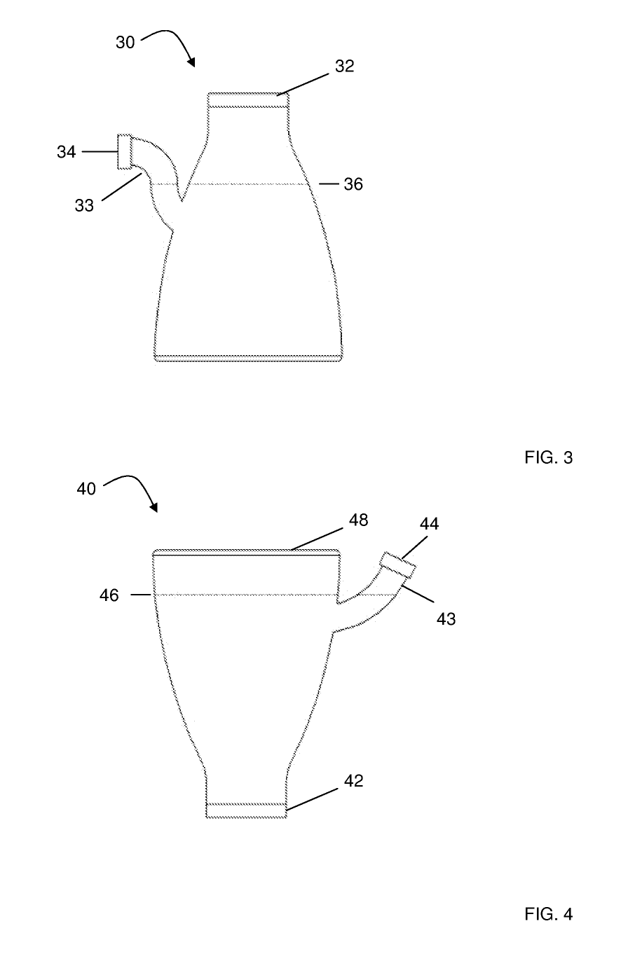

Container 20 may include a fill line 26. The auxiliary port of the container will be positioned such that its end with check 24 will be above the fill line. Thus, the auxiliary port may be at any location along the sidewall of the container as long as its end is situated above the fill line. Furthermore, the configuration of the auxiliary port may be adjusted for ease of filling. Another example of an auxiliary port is shown as 33 in FIG. 3, in which check 34 is above fill line 36.

In some embodiments, the holding container may connect with the body on its upper surface also referred to as top fed or gravity fed system. Such a system may not require a pressurized system for introducing air via an inlet to the body. With such a system, the holding container is adapted to fit on a top surface of the body. A suitable example of such a holding container is shown in FIG. 4, in which the fit between container 40 and a body of a spray system occurs at 42, which may be by force fit or screw fit or a turn lock, as suitable examples, or may be a mechanical release located on the body of the spray system. Container 40 will include a fill line (46). The location of auxiliary port 43 will be such that its end with check 44 is above the fill line. Container 40 may be sealed at the top end (48). Container 40 will not require an additional opening for use during operation. In addition, in certain embodiments, check 44 will remain closed during operation.

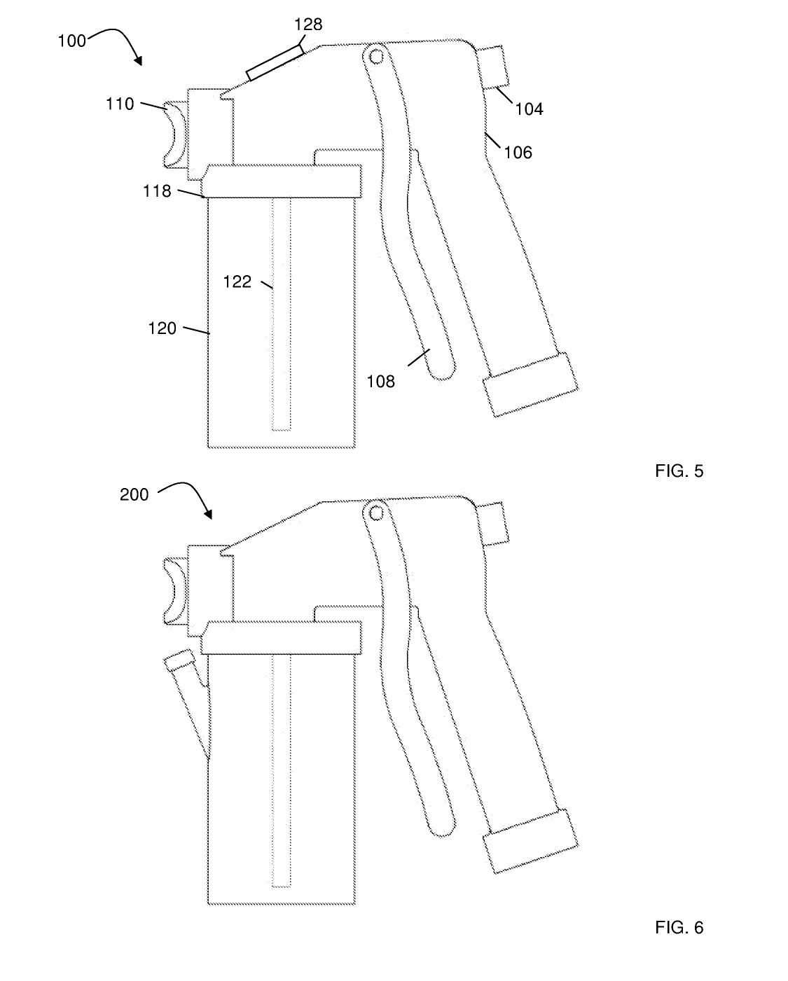

In still another embodiment, a spray system 100 comprises an air inlet 104, a body or housing 106, a trigger 108 operable with an outlet 110 and a holding container 120, as depicted in FIG. 5. The air inlet is in communication with a hose or piping or tubing (not shown) that is in direct communication with pressurized system for introducing compressed air into the inlet. Compressed air enters via the inlet and the flow of material is adjusted by way of trigger 8. The holding container houses material to be sprayed or coated. The spray or coating material exits the holding container through elongated member 122, which leads to outlet 110 and departure of the material from the system. Holding container 120 is filled or refilled through auxiliary port 128 on housing 106; auxiliary port 128 may include a check at its end, such as a cap or seal or valve. In such an embodiment, the auxiliary port is accessed through the housing, a shown, or its shroud, not shown. The check may be a flip cap, or secured by force fit or screw fit or a turn lock or a fit that transitions between an open and closed position. Thus, in such an embodiment, the holding container does not need to be removed in order to fill or refill with the spray or coating material.

Still further embodiments are depicted in FIGS. 6, 7 and 8.

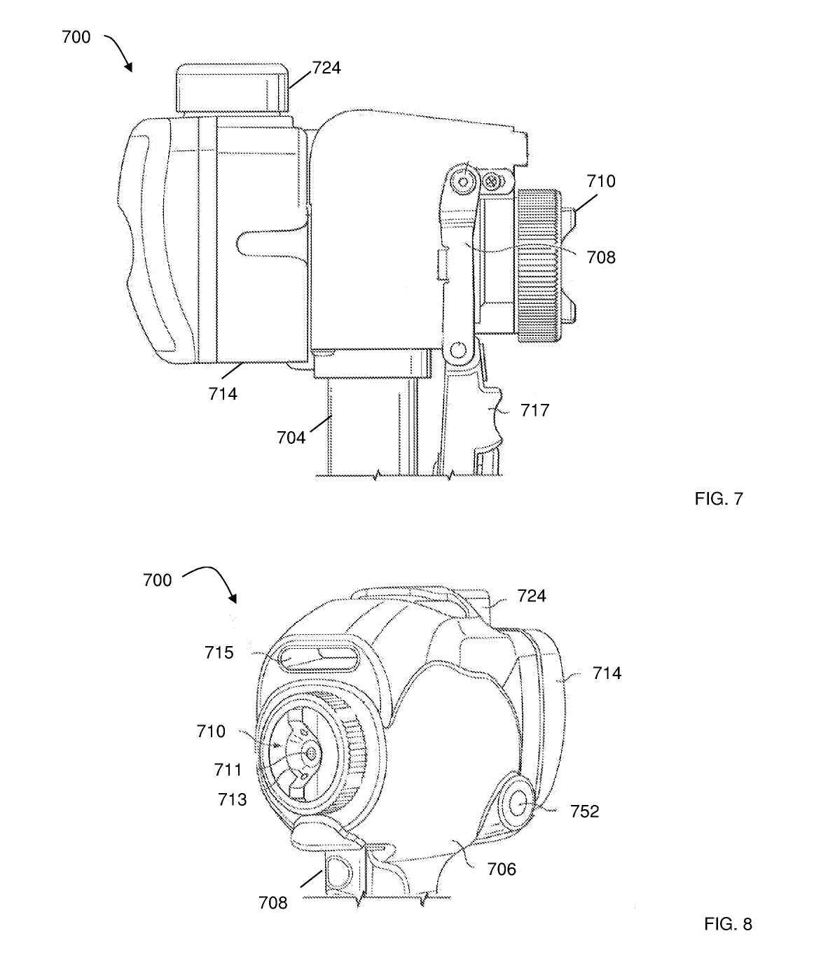

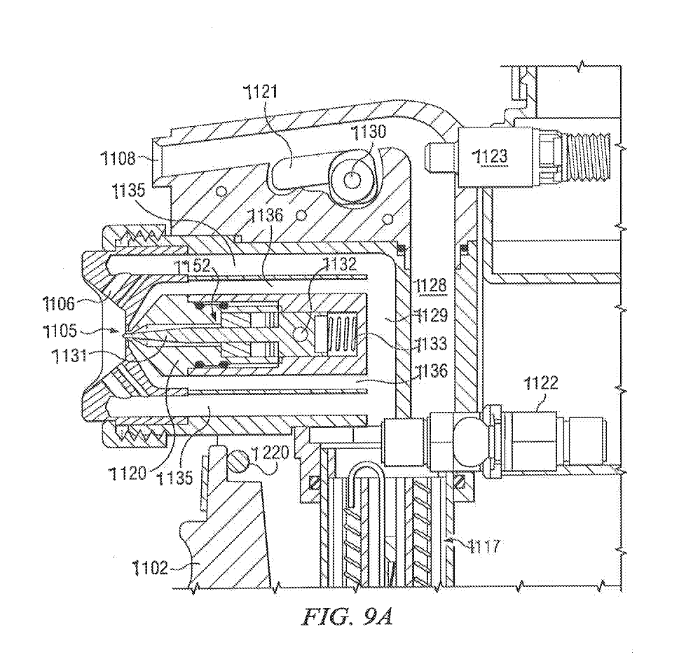

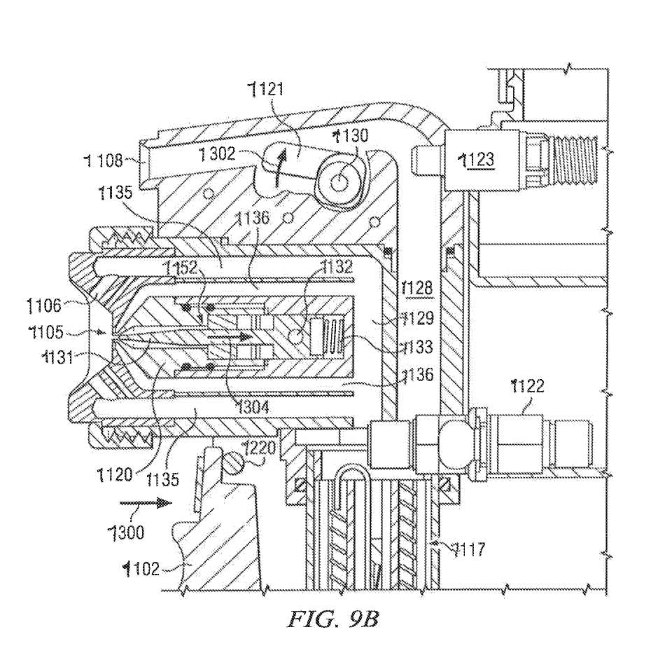

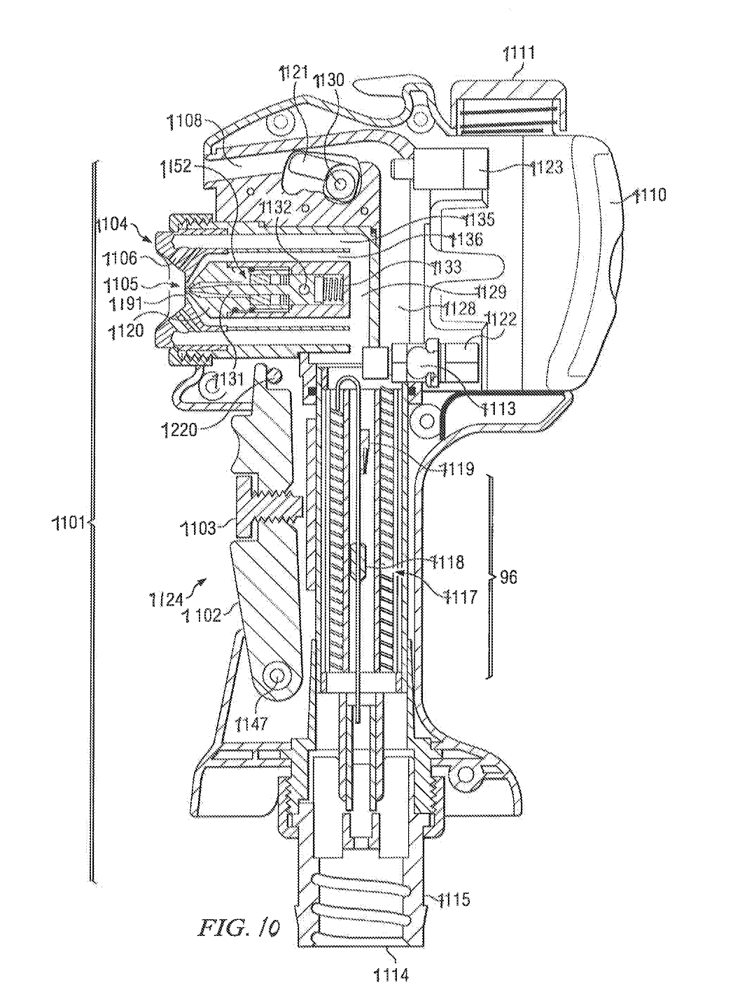

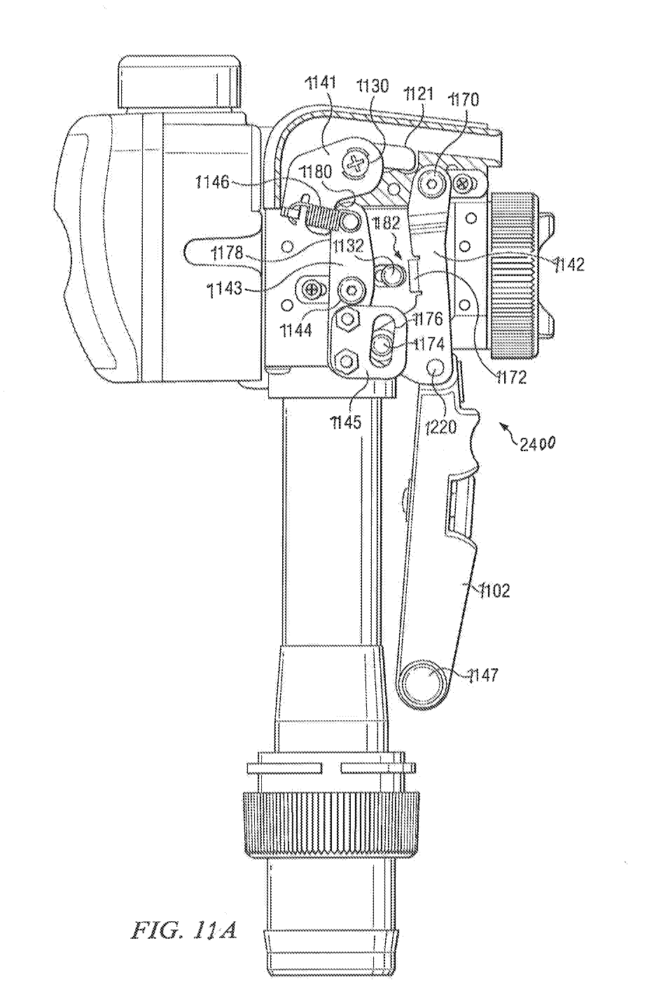

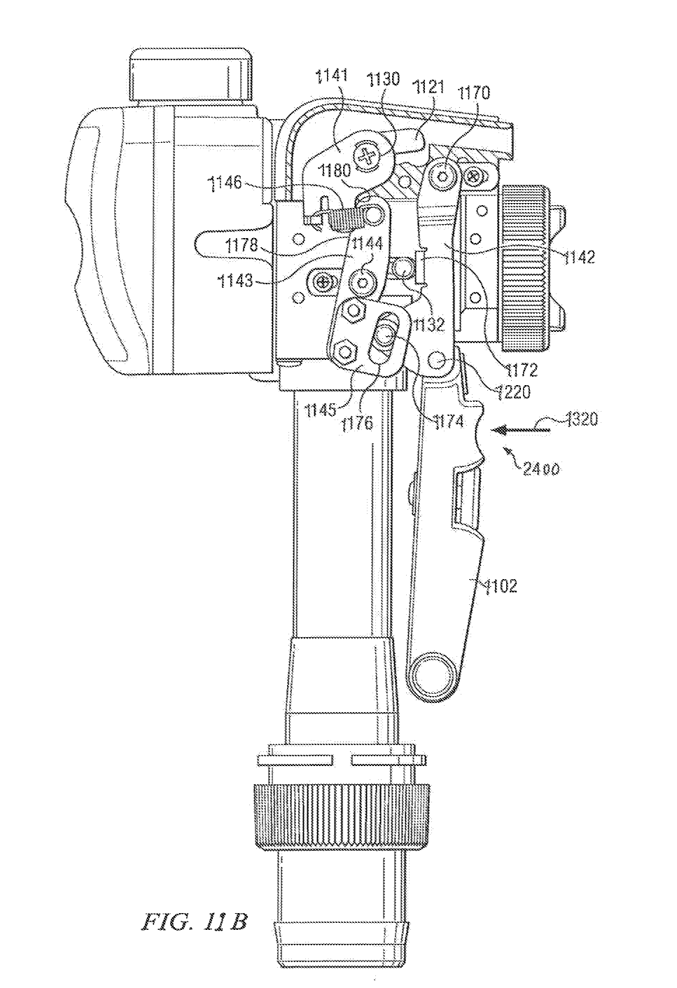

FIGS. 7 and 8 illustrate another representative system comprising a container operable as a container. In the representative embodiments, the system includes housing 706, air inlet 704 and outlet 710 with one or more nozzle jet outlets or ports 711, 713, one of which may be for shaped air. The system may also include an auxiliary air inlet. An optional heated or non-heated air outlet 715 may also be included. In addition or as an alternative, an internal check (e.g., needle valve or flap valve and/or spring and/or cable, pivot and string operation) may be configured with the outlet 710 to control or block output of a coating or spraying material from the outlet (see FIGS. 9A, 9B, 10). A holding container 710 is cooperative with the housing and located at a rear end of the body of the sprayer. The holding container 710 generally comprises a single unit or tank having a material for output or spray application. The unit may be filled through an auxiliary port while the holding container is cooperative with and in contact with the body and/or during operation. The auxiliary port has its own check 724 at its end, which operationally transitions from an open to closed position. The check may be cap or seal or valve or the like. The check may be removable and or affixed at or near the end. The check may be configured as a flip cap, may secure by force fit or screw fit or a turn lock or any suitable fit that transitions between open and closed positions. Location of the auxiliary port is flexible, as long as the location is generally above the fill line (not shown). The container 714 is, in one embodiment, detachable through actuation of a mechanical release or button 752 on the body of the spray system. The container may also be configured for alternative fits with the housing, including a force fit or screw-type fit or latch-fit (not shown). This allows an operator to change the spray or coating material by changing only the holding container. In FIG. 7, the container is shown in one embodiment. The container may also be raised above or have a height that is greater than the spray housing. The container may also fit on a top surface of the housing and be configured as described herein.

In FIG. 7 the air inlet 704 is provided at a base of the body. A connector may be positioned between the inlet and a hose or piping or tubing (not shown) to connect the hose and the sprayer; the hose is generally in direct communication with a pressurized system for introducing compressed air into the inlet. Flow is adjusted by way of trigger 708 including an external portion for articulation 717. The limit of actuation of the trigger is controlled, generally by a set screw (not shown). Said trigger may be cooperative with the internal check (e.g., needle valve or flap valve and/or spring and/or cable, pivot and string operation/actuation) to control or block output of the coating or spraying material from the outlet (see FIGS. 9-12). Upstream and downstream of the internal check are pathways that communicate with internal check to control air flow and flow of the material from the container. As such, the trigger may include a controller adapted to proportionally control actuation of the internal check and air valve in response to actuation of the trigger. In such embodiments, a warm air outlet, when included, is separate from the spray material outlet. The warm air outlet is adapted to deliver heated air in a warm air stream directed to mix with and warm the material produced by the outlet. The material delivered from the spray system described may, in some embodiments, be a finely atomized spray cloud. Embodiments for delivery of the air and material are further described below.

Reference is now made to FIG. 10 which illustrates a cross sectional view of the hand held spray system, such as one shown in FIG. 7. Air is received at the air inlet 1114 at the base of the handle portion 96. The received air passes up through the handle portion 96. The air heating system 1117 is installed in the handle portion 96 within the ducting carrying the air received at inlet 1114.

The heating system 1117 includes a thermal fuse 1118 and a thermal switch 1119 (in the form, for example, of a thermostat) functioning as safety devices with respect to sprayer operation so as to protect against an overheating or malfunctioning situation. Power to the heating system 1117 is supplied by power lines (not shown). In some embodiments, said heating system includes a cylindrical tube support with a ceramic core installed within the tube support and a mica wrap positioned between the inner surface of the tube support and the outer periphery of the ceramic core, wherein the ceramic core is formed to include a central longitudinal channel and a plurality of peripheral longitudinal channels (channels are sized to permit flow of air through the heating system 1117). The power lines pass through a central longitudinal. A thermal fuse 1118 and thermal switch 1119 are installed within the central longitudinal channel. A coiled resistance wire 1212 is installed within each one of the peripheral longitudinal channels. The coiled resistance wires are electrically connected to each other and to the power lines.

The heating system 1117 is designed to quickly ramp up to a desired air heating temperature and maintain that temperature over the course of a spray session. In a preferred operational scenario, the heating system 1117 is controlled on initial start up of the spray system in the high power configuration so as to achieve fast temperature rise time. The system may then switch operational power to a reduced medium or low power level depending on user desire and comfort.

Again referring to FIG. 10, after passing through the heating system 1117, air (now heated air) passes through internal ducting and is made available within the hand held sprayer for a number of purposes. Initially, heated air is delivered to a heat port air channel 1128. This heat port air channel 1128 is coupled to the heated air outlet 1108 through the air valve 1121 for relatively low pressure air delivery in the air stream 37. The air valve 1121 in the illustrated configuration comprises a flap valve. The flap valve is mounted to a pivot point 1130 and is actuated by the controller 1124 in a manner to be described in response to trigger 1102 actuation. When closed, the flap valve stops the flow of heated air from heat port air channel 1128 to the heated air outlet 1108. Second, the heated air in the heat port air channel 1128 is coupled through an inlet check valve 1123 to the supply container 1110. The check valve 1123 only permits air to enter the supply container 1110, and thus the air supplied from the heat port air channel 1128 functions to pressurize the supply container 1110. Third, the heated air is delivered to a nozzle air channel 1129 (separate from the heat port air channel 1128). This nozzle air channel 1129 is coupled to the pattern shaping air ports 1106 (through pattern shaping air channel 1135) so as to supply relatively higher pressure pattern shaping air for the nozzle 1104. This nozzle air channel 1129 is further coupled to the air atomization ports 1191 (through atomization air channel 1136) so as to supply relatively higher pressure atomizing air at the spray jet outlet 1105 of the nozzle 1104. It will be understood that the air pressure in the heat port air channel 1128 and nozzle air channel 1129 is dependent on the actuation of the air valve 1121. As the air valve 1121 closes, pressure rises in the heat port air channel 1128 and nozzle air channel 1129 thus providing increased air flow at the pattern shaping air ports 1106 and air atomization ports 1191. Conversely, as the air valve 1121 opens, pressure decreases in the heat port air channel 1128 and nozzle air channel 1129 due to the delivery of the heated air stream 37 from the low pressure heated air outlet 1108 (and thus reduced air flow will be available at the pattern shaping air ports 1106 and air atomization ports 1191).

The controller 1124 for the sprayer includes a trigger 1102 mounted to the handle portion 96. A first end of the trigger 1102 is mounted to a pivot 1147. The other end of the trigger actuates a control linkage mechanism (to be described) of the controller 1124 through a pin 1220. When the trigger 1102 is actuated, the trigger mechanism rotates about the pivot 1147 and applies force against the pin 1220. Movement of the pin 1220 (in response to the force applied by actuation of the trigger 1102) causes the control linkage mechanism of the controller 1124 to move the air valve 1121 (i.e., adjust its open/closed condition). When the trigger 1102 is in a fully released position, the control linkage mechanism of the controller 124 permits the air valve 1121 to assume a fully open position. As the trigger 1102 is actuated, the control linkage mechanism of the controller 1124 begins to close the air valve 1121. As the trigger 1102 moves towards the fully actuated position, the control linkage mechanism of the controller 1124 moves the air valve 1121 towards a fully closed position. The set screw 1103 provides a mechanism for controlling the maximum degree of trigger 1102 actuation and thus can limit the degree of closure of the air valve 1121 in response to full actuation of the trigger 1102.

The material for the spraying operation is sourced from the supply container 1110. The spray material in the supply container 110 is coupled through an outlet quick connect valve 1122 through internal ducting (not explicitly shown) to the nozzle spray jet outlet 1105. The nozzle 1104 is of the air-assisted atomizing type. High pressure air exiting from the air atomization port 1191 atomizes the spray material provided from the supply container 1110 and passing through the quick connect valve 1122 and internal ducting to the nozzle spray jet outlet 1105 to form a spray cloud. The outlet quick connect valve 1122 for the supply container 1110 in this implementation does not function to control the state or rate of fluid flow or the size of the atomized spray cloud. Rather, a separate material control valve 1152 is provided in the nozzle 1104. This material control valve 1152 in the illustrated configuration comprises a needle valve (to be described) associated with the nozzle jet outlet 1105.

When the material control valve 1152 is closed, the flow of material, often in the form of a liquid, from the supply container 1110 to the nozzle spray jet outlet 1105 is blocked. As the material control valve 1152 opens, material from the supply container 1110 flows to nozzle spray jet outlet 1105. This flow is assisted by the fact that the supply container 1110 has been pressurized by heated air passing into the supply container 1110 through the inlet check valve 1123. In a non-needle valve implementation, the outlet check valve 1122 may be configured to implement the functionality of the material control valve 1152 (for example through controlling suction of material from the supply container 1110 to nozzle spray jet outlet 1105).

As discussed above, the controller 1124 for the hand held sprayer in a preferred implementation controls at least the state of, and perhaps also the rate of fluid flow provided by, the material control valve 1152. In one valve configuration, the needle valve comprises a fluid flow needle 1131 for the material control valve 1152 that is biased by a spring 1133 in a closed position that shuts off the flow of material to the nozzle spray jet outlet 1105. The fluid flow needle 1131 moves within the nozzle 1104 in response to actuation of pin 1132. When the trigger 1102 is actuated, the trigger mechanism rotates about the pivot 1147 and engages the pin 1220. Movement of the pin 1220 (in response to the trigger 1102 actuation) causes the control linkage mechanism of the controller 1124 to move the needle valve pin 1132 and open the material control valve 1152 by moving the fluid flow needle 1131 moves within the nozzle 1104. When the trigger 1102 is in a fully released position, the control linkage mechanism of the controller 1124 (along with spring 1133) sets the fluid flow needle 1131 of material control valve 1152 into a fully closed. As the trigger 1102 is further actuated, the control linkage mechanism of the controller 1124 begins to open the needle valve (after a delay as described below). When the trigger 1102 moves towards the fully actuated position, the control linkage mechanism of the controller 1124 sets the fluid flow needle 1131 into a position where the material control valve 1152 is fully open. The set screw 1103 provides a mechanism for controlling the maximum degree of trigger 1102 actuation and thus can limit the degree of opening the material control valve 1152 in response to full actuation of the trigger 1102.

Reference is now made to FIGS. 9A and 9B which illustrate cross sectional views of the sprayer shown in FIG. 10 focus on a representative operation of air and material control valves.

In FIG. 9A, the sprayer is illustrated in an operational configuration where the trigger 1102 is fully released. The air valve 1121 is in the fully open position, and the valve 1152 is in the fully closed position. In this case, pressure is low in the heat port air channel 1128 and the supply container 1110 is in a relatively low or no pressurized condition (supporting low flow rates to the nozzle). FIG. 9A shows the fluid flow needle 1131 of the needle-type valve 1152 positioned within a fluid tip body 1120 to fully close the nozzle jet outlet 1105. The spring 1133 biases the fluid flow needle 1131 against the nozzle jet outlet 105 of the fluid tip body 1120 in this closed position.

FIG. 9B illustrates that the trigger 102 has been actuated to some degree (as indicated by arrow 300). The air valve 1121 has moved to a partially closed position, and the valve 1152 has moved to a partially open position. In this case, pressure increases in the heat port air channel 1128, air flows through the valve 1123 and the supply container 1110 is in a relatively medium pressurized condition (supporting medium material flow rates to the nozzle). FIG. 9B shows that the flap valve of the air valve 1121 has moved (arrow 1302) about the pivot 130 to partially close the ducting leading to the heated air outlet 1108. FIG. 9B further shows that the fluid flow needle 1131 of the needle-type valve 1152 has moved (arrow 1304) within the fluid tip body 1120 to partially open the nozzle jet outlet 1105 (and compress spring 1133). The movements 1302 and 1304 of the flap valve (of the air valve 1121) and the fluid flow needle 1131 (of the valve 1152) occur in response to actuation of the pin 1220 in response to the movement 1300 of the trigger 1102. The trigger 1102 actuates a control linkage mechanism (to be described) of the controller 24 through the pin 220 to move 1302 the air valve 1121 and move 1304 the valve 1152 (through pin 1132).

When trigger 1102 is fully actuated, air valve 1121 has moved to a fully closed position, and the valve 1152 has moved to a fully open position. In this case, pressure further increases in the heat port air channel 128, air flows through the valve 1123 and the supply container 1110 is in a relatively high pressurized condition (supporting higher spray material flow rates to the nozzle). The flap valve of the air valve 1121 has moved about the pivot 1130 to fully close the ducting leading to the heated air outlet 1108. The fluid flow needle 1131 of the needle-type valve 1152 has further moved within a fluid tip body 1120 to fully open the nozzle jet outlet 1105 (and further compress spring 1133). The movement of the flap valve (of the air valve 1121) and the fluid flow needle 1131 (of the valve 1152) occurs in response to actuation of the pin 1220 in response to the movement 1302 of the trigger 1102. The trigger 1102 actuates a control linkage mechanism (to be described) of the controller 1124 through the pin 1220 to move the air valve 1121 and move the valve 1152 (through pin 1132).

It will be noted that the fluid tip body 1120 is positioned adjacent the atomization air channel 1136. As the atomization air channel 1136 is coupled to receive heated air from the heating system 1117 through the nozzle air channel 1129, it will be noted that the heated air will also heat the fluid tip body 1120. This advantageously will provide some warming of the spray material in the tip at the nozzle jet outlet.

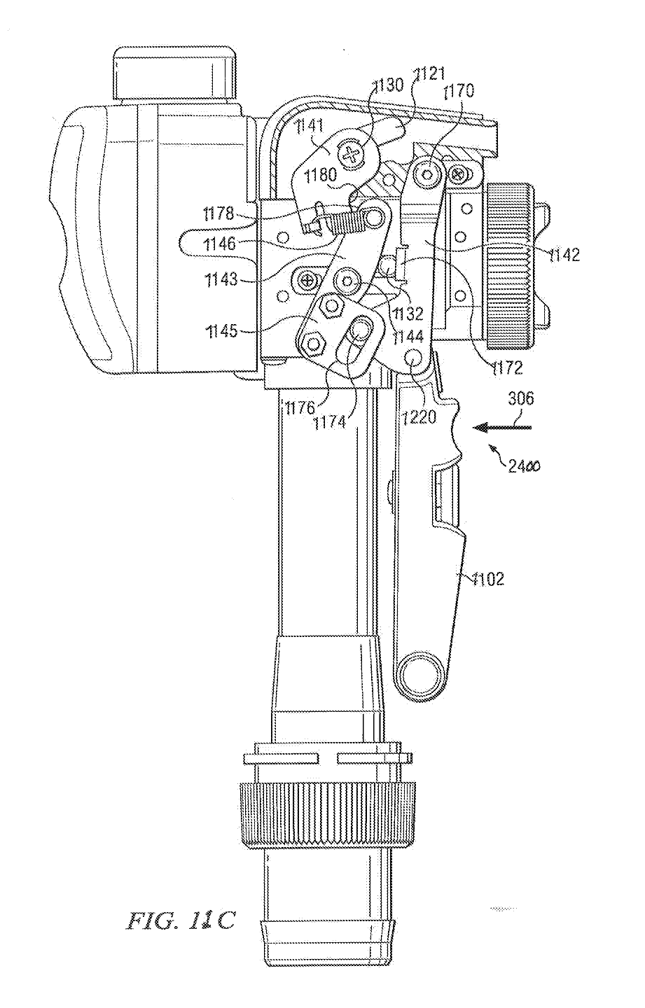

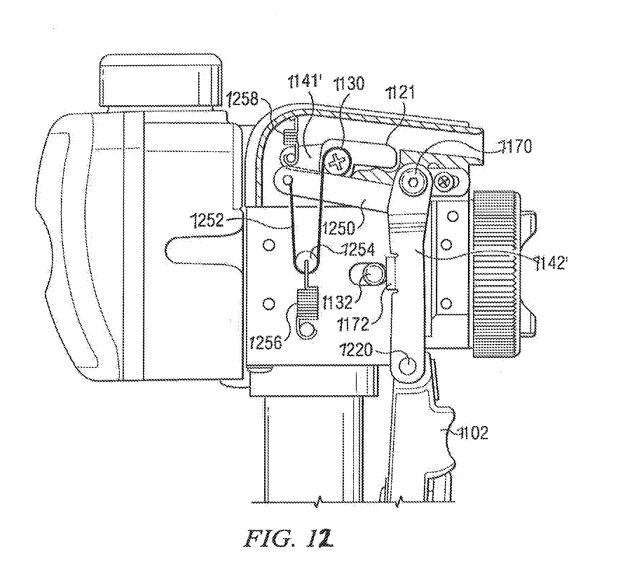

As described above, the controller 1124 may comprise any suitable electrical, mechanical, or electro-mechanical control system that is responsive to user actuation to control operation of the hand held spray member in support of varying operating modes. In the implementation of FIGS. 9A-9B, the controller has an implementation using a mechanical control system. Some embodiments, e.g., FIGS. 11A-11C, described herein illustrate a mechanical control system. Another representative embodiment illustrates a cable and string operation (FIG. 12).

FIG. 11A corresponds with FIG. 9A but shows the mechanical control system of controller 2400. The sprayer is illustrated in an operational configuration where the trigger 1102 is fully released. As shown, the air valve 1121 is in the fully open position. Pin 1132 for the needle valve of the valve 1152 is shown in a position where the valve 1152 will be in the fully closed position (as shown in FIG. 9A where the fluid flow needle 1131 of the needle-type valve 1152 positioned within a fluid tip body 120 to fully close the nozzle jet outlet 1105).

In one form, a mechanical control system for the controller 2400 is in the form of a mechanical linkage design (it being understood that such a linkage design is only one example of a mechanical control system and that electrical and electro-mechanical control systems could alternatively be provided). A trigger arm 1142 is coupled at a first end to a pivot 1170 and at a second end to the pin 1220. An actuation pad 1172 is provided on the trigger arm 1142 approximately midway between the first and second ends and in a position to actuate the pin 1132 of the fluid flow needle 131 of the valve 1152. Responsive to actuation of the trigger 1102, the trigger arm 1142 rotates about pivot 170 and the actuation pad 1172 moves into contact with the pin 1132. The initial contact of actuation pad 1172 with the pin 1132 will not cause any change in the valve 1152. However, as the trigger 1102 is further actuated, the continued rotation of the trigger arm 1142 about pivot 1170 will cause a movement of the pin 1132. The movement of pin 1132 produces a corresponding movement in the fluid flow needle 1131 within the fluid tip body 1120. This movement compresses the spring 1133 and opens the nozzle spray jet outlet 1105. When the trigger 1102 is released, the spring 1133 causes the fluid flow needle 131 to return to its closed position within the fluid tip body 1120, and further returns pin 1132 to the position shown in FIG. 9A and 11A.

The trigger arm 1142 further includes a pin 1174 located near the second end and offset from the pin 1220. The pin 1174 is positioned within a slot 1176 of an actuator cam link 1145. The cam link 1145 is mounted at a first end of an air valve link actuator 1143. The air valve link actuator 1143 is mounted for rotation at about its center point to a pivot 1144. A second end of the air valve link actuator 1143 provides a first valve actuator surface 1178. The air valve 1121 comprises a vane member and an actuating arm member 1141. The vane member and actuating arm member 1141 are coupled together and rotate about the pivot 1130. The actuating arm member 1141 includes second valve actuator surface 1180. The first valve actuator surface 1178 and second valve actuator surface 1180 are not fixedly connected to each other, but rather are positioned to slide relative to each other during movement of the actuating arm member 1141 and air valve link actuator 1143. A tension spring 1146 is provided to couple the second end of the air valve link actuator 1143 to the actuating arm member 1141 and bias first valve actuator surface 1178 and second valve actuator surface 1180 in sliding contact with each other.

The tension spring 1146 further allows air valve actuator link 1143 to continue moving after air valve 1121 is fully closed. This is desired to allow valve 1152 to open still further in response to trigger 1102 actuation and independent of the fully closed position of the air valve 1121. In this mode, the second valve actuator surface 1180 will separate from first valve actuator surface 1178.

Responsive to actuation of the trigger 1102, the trigger arm 1142 rotates about pivot 1170, and the pin 1174 actuates the cam 1145 by sliding within the slot 1176. This causes the air valve link actuator 1143 to rotate about pivot 1144. The tension spring 1146 maintains contact between the first valve actuator surface 1178 on the air valve link actuator 1143 and the second valve actuator surface 1180 of the actuating arm member 1141. These surfaces slide against each other as the actuating arm member 1141 rotates about pivot 1130 in response to the rotation of the air valve link actuator 1143. The rotation of the actuating arm member 1141 produces a corresponding rotation of the vane member about pivot 1130 so as to move the vane of the air valve 1121 towards the fully closed position (it being remembered that at the same time the valve 1152 is moving towards the fully open position). As discussed above, when the trigger 1102 is released, the spring 1133 will cause the fluid flow needle 1131 to return to its closed position within the fluid tip body 1120 and return pin 1132 to the position shown in FIG. 9A and 11A. In the absence of any trigger 1102 actuation, the heated air flowing past the air valve 1121 will push the vane of the air valve 1121 towards the fully open position. A return spring (not shown) coupled to trigger arm 1142 may also be used to return all linkages to the un-actuated position (see, FIG. 11A). This causes rotation of the actuating arm member 1141 about pivot 1130. The tension spring 1146 coupled the end of actuating arm member 1141 will pull on air valve link actuator 143 while the first valve actuator surface 1178 on the air valve link actuator 1143 slides against the second the second valve actuator surface 1180. This produces a rotation of the air valve link actuator 1143 about pivot 1144. Responsive thereto, the cam 1145 and trigger arm 1142 are returned to the positions shown in FIGS. 9A and 11A.

It will be noted that there is an offset 1182 between the actuation pad 1172 of the trigger arm 1142 and the pin 1132 of the fluid flow needle 1131 when the valve 1152 is in the fully closed position and the air valve 1121 is in the fully open position (i.e., when the spray device trigger 1102 is not actuated as shown in FIG. 9A). The offset 1182 permits an initial actuation of the trigger 1102 to start closing the air valve 1121 before a further actuation of the trigger 1102 starts opening the valve 1152. This is illustrated in FIG. 11B. It will be noted that trigger 1102 has been partially actuated (arrow 1320). The offset 1182 (FIG. 11A) has been eliminated and the actuation pad 172 of the trigger arm 1142 is now in contact with the pin 1132 of the fluid flow needle 1131. However, this initial partial trigger 1102 actuation 1320 has not caused any movement of the pin 1132 and thus the valve 1152 remains closed (the fluid flow needle 131 of the needle-type valve 1152 positioned within a fluid tip body 1120 to fully close the nozzle jet outlet 1105). Notwithstanding the foregoing, however, it will be noted that the configuration of the controller 2400 and mechanical linkages has caused the trigger arm 1142 to rotate about pivot 1170, the pin 1174 to actuate the cam 1145 by sliding within the slot 1176, the air valve link actuator 1143 to rotate about pivot 1144, the first valve actuator surface 1178 on the air valve link actuator 1143 to slide with respect to the second valve actuator surface 1180, and the actuating arm member 1141 to rotates about pivot 1130 in response to tension spring 1145 so as to move the vane member and partially close the air valve 1121.

With reference once again to FIG. 9A, the foregoing operation to partially close the air valve 1121 prior to any action to open the valve 1152 is advantageous because the partial closure of the air valve 1121 will raise the air pressure within at least the nozzle air channel 1129. An elevation in air pressure within the nozzle air channel 1129 produces an increased air flow rate through the pattern shaping air channel 1135 to the pattern shaping air port 1108 and atomization air channel 1136 to the air atomization port 1191. Then, as shown in FIG. 9B, when the fluid flow needle 1131 of the needle-type valve 1152 does move 1304 to partially open the nozzle jet outlet 1105, a suitable air flow at both the pattern shaping air port 1108 and air atomization port 1191 is present to generate the spray cloud. FIG. 11B shows the linkage position in response to the initial actuation of the trigger 1102 just prior to the further actuation 300 of the trigger 1102 in FIG. 9B to partially open the valve 1152.

In FIG. 11C sprayer is illustrated in an operational configuration where the trigger 1102 has been fully actuated. As shown, the air valve 1121 has moved to the fully closed position. Pin 1132 for the needle valve of the valve 1152 is shown to have moved to a position where the valve 1152 will be in the fully open position (where the fluid flow needle 1131 of the needle-type valve 1152 positioned within a fluid tip body 1120 to fully open the nozzle jet outlet 1105).

The linkage configuration of FIGS. 10A to 10C represents one representative and possible mechanical configuration. A different mechanical configuration is shown in FIG. 12 which utilizes a cable and string operation. A trigger arm 1142′ is coupled at a first end to a pivot 1170 and at a second end to the pin 1220. An actuation pad 1172 is provided on the trigger arm 1142′ approximately midway between the first and second ends and in a position to actuate the pin 1132 of the fluid flow needle 131 of the valve 1152. Responsive to actuation of the trigger 102, the trigger arm 1142′ rotates about pivot 1170 and the actuation pad 1172 moves into contact with the pin 1132. The initial contact of actuation pad 1172 with the pin 1132 will not cause any change in the valve 1152. However, as the trigger 1102 is further actuated, the continued rotation of the trigger arm 1142′ about pivot 1170 will cause a movement of the pin 1132. The movement of pin 1132 produces a corresponding movement in the fluid flow needle 1131 within the fluid tip body 1120. This movement compresses the spring 1133 and opens the nozzle spray jet outlet 1105. When the trigger 1102 is released, the spring 1133 causes the fluid flow needle 1131 to return to its closed position within the fluid tip body 1120, and further returns pin 1132 to the position shown in FIG. 12.

The trigger arm 1142′ includes an extending member 1250 which extends from approximately the first end in a perpendicular direction. A cable 1252 is connected at the distal end of the extending member 250. The cable 1252 wraps around a pulley 1254 that is coupled to a fixed point by a tension spring 1256. The air valve 1121 comprises a vane member and an actuating arm member 1141′. The vane member and actuating arm member 1141′ are coupled together and rotate about the pivot 1130. After wrapping around the pulley 1254, the cable 1252 is further wrapped around the pivot 1130 and connected to the vane of the air valve 1121. A return spring 1258 is coupled to the end of the actuating arm member 1141′.

Responsive to actuation of the trigger 1102, the trigger arm 1142′ rotates about pivot 1170, and the extending member 1250 pulls up on cable 1252. The movement is translated by the pulley 1254 into a downward force on cable 1252 with respect to the pivot 130 resulting in a rotation of the vane member and actuating arm member 1141′ about pivot 1130, a tensioning of spring 1258 and a closing of the air valve 1121. When the trigger 1102 is released, the spring 1258 pulls on actuating arm member 1141′ causing a rotation about the pivot 1130 and the opening of the air valve 1121. Tension on the cable 1252 reverses direction and the mechanical configuration returns to the position shown in FIG. 12.

The foregoing description includes examples embodying, at least in part, certain teachings of the invention. The invention, as defined by the appended claims, is not limited to the described embodiments. Alterations and modifications to the disclosed embodiments may be made without departing from the invention. The meaning of the terms used in this specification are, unless expressly stated otherwise, intended to have ordinary and customary meaning and are not intended to be limited to the details of the illustrated structures or the disclosed embodiments. Although the foregoing description of embodiments have shown, described and pointed out certain novel features of the invention, it will be understood that various omissions, substitutions, and changes in the form of the detail as illustrated as well as the uses thereof, may be made by those skilled in the art, without departing from the scope of the invention. Particularly, it will be appreciated that the one or more embodiments may manifest itself in other shapes and configurations as appropriate for the end use of the article made thereby.

What is claimed is:

1. A spray system comprising:
a means for accepting a spray material;
a means for exiting the spray material;
a means for holding the spray material in operable communication with the means for accepting, wherein the means for holding is continuous and does not include separable layers; and
a means for filling the means for holding with the spray material, wherein the means for filling is separate from the means for holding and does not require the means for holding to be removed from the system, wherein the means for filling includes a means for opening and closing that is opened when filling and may be opened during operation of the spray system.

2. The spray system of claim 1, wherein the means for accepting is a spray device further comprising an inlet in communication with a pressurized system for delivering pressurized air to the spray device.

3. The spray system of claim 1, wherein the means for exiting is a nozzle.

4. The spray system of claim 1, wherein the means for exiting is a nozzle that finely atomizes the spray material.

5. The spray system of claim 1, wherein the means for exiting is a nozzle that heats the spray material before exiting.

6. The spray system of claim 1, wherein the means for holding does not include a collapsible portion.

7. The spray system of claim 1, wherein the means for holding has a primary opening for communication with the means for accepting and the primary opening is continuous.

8. The spray system of claim 1, wherein the means for holding has a primary opening for communication with the means for accepting and the primary opening when in communication with the means for accepting does not include a valve, cap or lid.

9. The spray system of claim 1, wherein the system is a closed system.

10. A spray system comprising:
a closed system that includes a spray gun having an air inlet, an outlet and trigger for adjusting flow of spray material;
a holding container for holding the spray material in operable communication with the spray gun, wherein the holding container includes a primary opening and an auxiliary port, wherein the holding container does not include a liner and is fitted to the spray gun through the primary opening that is continuous with the holding container, wherein the primary opening does not include a separable valve, and wherein the auxiliary port allows filling of the spray material into the holding container without removing the holding container from the spray gun.

11. The spray system of claim 10, wherein the auxiliary port includes a one-way valve.

12. The spray system of claim 10, wherein the flow of material is further adjusted by an internal valve system.

13. The spray system of claim 10, wherein the holding container may be released from the spray gun by a mechanism contained on the spray gun.

14. The spray system of claim 10, wherein the holding container is rigid and does not include one or more of a separable layer or a collapsible layer.

15. The spray system of claim 10, wherein the spray gun includes a mechanism for heating the spray material before it exits the spray gun.

16. The spray system of claim 10, wherein the auxiliary port may be opened while the system in operating.

17. The spray system of claim 10, wherein the system includes a release mechanism for releasing the holding container that is located on the spray gun.

18. A non-collapsible holding container adapted for and in operable communication with a spray system,
wherein the container includes a primary opening that does not include a valve that transitions from an open position and a closed position and an auxiliary port that maintains pressure in the spray system during operation,
wherein the holding container does not need to be removed from the system to be filled or refilled with a spray or coating material.

19. The holding container of claim 18, wherein the holding container does not include a separable layer or liner.

20. The holding container of claim 18, wherein the holding container may be released from the spray system by a mechanism located on the spray gun.
